(19) United States
(12) Patent Application Publication
(10) Pub. No.: US 2015/0193703 A1
(43) Pub. Date: Jul. 9, 2015

(54) Method for Facilitating Travel Plans and Managing a Communal Budget

(71) Applicant: Maryssa Jane Salomon, West Orange, NJ (US)

(72) Inventor: Maryssa Jane Salomon, West Orange, NJ (US)

(21) Appl. No.: 14/589,946

(22) Filed: Jan. 5, 2015

Related U.S. Application Data
(60) Provisional application No. 61/923,391, filed on Jan. 3, 2014.

(51) Int. Cl. G06Q 10/02; G06Q 10/10; G06Q 20/10; G06Q 40/00; G06Q 50/14

(52) U.S. Cl. CPC G06Q 10/025; G06Q 40/00; G06Q 50/14; G06Q 20/10; G06Q 10/1093

(57) ABSTRACT

A method for facilitating travel plans and managing a communal budget through a software program implemented as a website. A group of users have a communal account linked to a plurality of user accounts, wherein each of the plurality of user accounts is linked to a personal account. Funds are transferred from the personal account of each of the user accounts to the communal account, wherein the communal account is utilized to fund a group vacation. The group of users determine a destination selection that is used in conjunction with a total account balance of the communal account to provide a plurality of travel accommodations within the price range of the group of users. Modes of communication are provided to the group of users through a communications hub in order to share travel accommodations, and better organize the group vacation.

The current application claims a priority to the U.S. Provisional Patent application Ser. No. 61/923,391 filed on Jan. 3, 2014. The current application is filed on Jan. 5, 2015 while Jan. 3, 2015 was on a weekend.

### FIELD OF THE INVENTION

The present invention relates generally to travel planning software. More specifically, the present invention is a software for facilitating group travel plans and managing a communal travel budget, wherein the communal travel budget is utilized to provide relatable advertisements from third-party resource providers and filter deals based off of a communal account balance.

### BACKGROUND OF THE INVENTION

This invention is directed toward a method of allowing one or more persons to come together in a virtual and secure environment and pool together money and resources for travel. It also fulfills a secondary function of allowing sellers of goods and services to identify and market their services to fulfill specific travel needs and wants. It is difficult for groups to come together, plan a travel goal, assemble the resources, and apply them to carrying out their objective. More specifically, without a coordinating tool, discipline almost invariably breaks down and for some reason the goal is never achieved of traveling in a planned and resourceful manner, based on collective acquisition of resources, especially funding. This software will provide that disciplinary framework in a safe and secure environment.

The difficulty of the secondary goal of resource vendors to target accurately their clientele is reflected by the scattershot uncoordinated manner in which potential clients are contacted. That is clients frequently will receive advertisements not relevant to their immediate travel goals. For example, members of a group planning a trip to the Bahamas may receive promotions for hotels in Thailand, thus creating annoyance and waste. This invention will allow for specific directionality of resource notification not only because of the specific description of the group's travel destination but by participant requests.

Therefore it is an object of the present invention to provide the infrastructure for such a communication center that will allow both synchronous and asynchronous communication among and between members of the traveling group by voice, video, and writing within the confines of this website.

Another objective of the present invention is to make planning and booking a trip as a group with friends and family more convenient and effective for travelers; giving them time to collectively save up for an affordable vacation of their choice. Destination(s) planning will have to work within the time frame of the traveler/travelers for the value of the traveler/travelers.

A greater objective of the present invention is to reduce the stress of keeping all travelling parties on the same page at all times. Giving everyone in the travelling party access to one account and profile keeps the stress level at a low level during the planning process and makes it enjoyable and exciting again.

Also, another objective of the present invention is to minimize the waste of unwanted vacation deal ads. Companies spend millions of dollars on banners, pop ups, emails, and more to promote vacation deals, only to send them to people who, one, have no plans to travel and two, would not have the money to spend on impulse even if they would like to visit. Being able to see who is traveling where and when, and see what their budget looks like at the time makes it easy for vacation companies to choose whom to promote to and whom not to promote to. This means configuring all destination promo ads in a specific relation with what the consumer is in search of without having to search through unrelated options.

A further objective of the present invention is to allow travelers to have as much time as they would like to save and plan for their trip. Planning a vacation should be an exciting moment; consumers should not have to feel regret, forced or have a setback financially all because of an impulse decision they had to make because they did not want to miss out on a good deal. To continue, a goal of this invention is to make sure travelers are getting their time and money valued. Usually when travelers book a vacation on impulse they end up spending more than they would've paid if they saved far in advance.

Even with a small amount of money, travelers will be able to see exactly what they can afford, if anything. If the amount of money travelers have is too small, then the travelers will kindly be prompted that they cannot afford anything at the moment. However, all options available based on the traveler's account are displayed; even if a hotel room at a rest stop on the side of the road is the only option within the account price range. This will encourage the traveler to continue to save for better options while still showing the traveler that every hard earned dollar holds value.

### SUMMARY OF THE INVENTION

The present invention enables individuals as participants, group members, or users, to assemble in a virtual collective so as in a disciplined and coordinated manner to plan, acquire resources, and apply those resources to travel as a group. Pooled resources include material and finances, the finances specifically being drawn from individual bank accounts and specifically applied to achieving the group travel goals. This invention also allows for the communication among the participants to carry out their travel goals. A further goal of this invention is to enable resource providers, such as transportation companies and hotel chains, to direct advertisements to group participants in accordance to their wishes and travel goals.

It is a function of the present invention to serve as a travel coordinator that may be managed by the group as a committee or by a leader of the group. Including but not limited to these various activities, the coordinator relies on desired procedures, rules, and regulations to plan for travel, collect resources, make decisions, apply resources to carrying out travel plans, be a resource base (as in a library), conserve records, generate information, act as interlocutor to individuals and organizations outside the travel group, and manage security, among other functions.

### BRIEF DESCRIPTION OF THE DRAWINGS

FIG. 1 is a flowchart of the overall method for facilitating travel plans and managing a communal budget;

FIG. 2 is a flowchart thereof, further detailing steps for receiving final travel accommodations;

FIG. 3 is a flowchart thereof, further detailing steps for generating a communal schedule of availability for a group of users;

FIG. 4 is a flowchart thereof, further detailing steps for transmitting olfactory data through an arbitrary account;

FIG. 5 is a flowchart thereof, further detailing steps for transmitting motion data used to portray movements of an individual as a hologram;

FIG. 6 is a flowchart thereof, further depicting steps for allocating a total account balance among a plurality of travel accommodations;

FIG. 7 is a flowchart thereof, further detailing steps for communicably linking a plurality of user accounts through a communications hub;

FIG. 8 is a flowchart thereof, further detailing steps for communicably linking an arbitrary account to a third-party resource provider account through the communications hub;

FIG. 9 is a flowchart thereof, further detailing steps for communicably linking the arbitrary account to a banking institution account through the communications hub;

FIG. 10 is a flowchart thereof, further detailing steps for uploading an information file to be shared with the group of users through the communications hub; and

FIG. 11 is a flowchart thereof, further detailing steps for receiving funding from a third-party funding account.

### DETAIL DESCRIPTIONS OF THE INVENTION

All illustrations of the drawings are for the purpose of describing selected versions of the present invention and are not intended to limit the scope of the present invention.

The present invention is a method for facilitating travel plans and managing a communal budget through a software program, wherein the communal budget is utilized by third-party resource providers to present relevant advertisements as to the location of travel and the budget of the traveling group or individual. In the preferred embodiment of the present invention, the software program is employed through a website, wherein a plurality of users can register through the website and interact with each other through a plurality of user accounts. The website should be developed with security in mind, and as such, the website should incorporate the latest best industry practices in implementing online security, such as utilizing Hypertext Transfer Protocol Secure (HTTPS) for end to end communications. If the present invention is to be licensed, then ideally, the website has identifying information, such as a logo on each page to indicate the website as being a representative of the present invention.

All information processed through the website is recorded in a relational database (RDB), wherein the RDB and the software program are maintained according to the best current computer industry practices. Additionally, it is recommended that every interaction through the website is to be logged in a day to day file that is maintained by a systems administrator. Each file stored in the RDB will have a time stamp, with the option of being purged according to various parameters set by the owner of the website.

In order to utilize the features of the software program, each of the plurality of users must create or log-in to a user account. If a user is a new participant, then the user must create the user account by supplying login information, such as a username, password, email address, and answer to a security question. The password for the user account should utilize both letters and numbers to ensure secure and strong encryption of the user account. The login information is submitted by the user through a plurality of empty input fields provided through the website interface and saved in the RDB. The user may be prompted with a privacy statement and/or disclaimer of which the user must agree to prior to submitting the login information. Additionally, the user may be required to sign a waiver before or after submitting the login information, but prior to activation of the user account.

Other personal information may also be gathered and recorded in the RDB in addition to the login information. The personal information may be used to identify the user amongst other individuals in a group, provide contact information for third party resource providers, etc. Some examples of personal information that can be provided in addition to the login information include, but are not limited to, a first name, last name, address, city, state, zip code, phone number, age, or gender.

If the user has already established the user account and is returning to the website, then the user can log-in to the user account by submitting the login information supplied during the creation of the user account. For example, the user enters the username and password through provided input fields, wherein the username and the password are then verified and authenticated within the RDB. Upon successful authentication of the login information, the user is permitted access to the user account. Methodologies are also employed for recovering the login information in the event that the user has forgotten some or all of the login information required to gain access to the user account.

In the preferred embodiment of the present invention, if the user forgets the password, then the user is prompted to supply the username or email address, and then provide the answer to the security question. Upon successful verification of the answer to the security question and the username or email address, the password is sent to the email address. The user can then access the user account and change the password if desired. In other embodiments of the present invention, the password may be sent to the phone number of the user, or otherwise delivered to the user. If the username is forgotten, then only the email address needs to be supplied to retrieve the username.

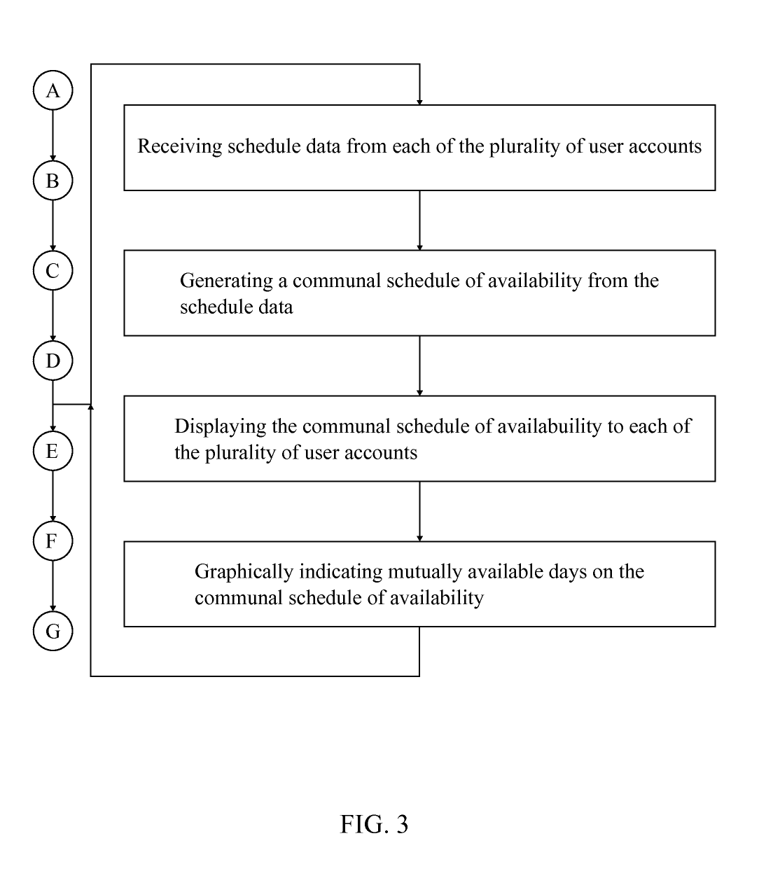

Once the plurality of user accounts is established for a group of users, then the group of users can begin to plan and organize a vacation. Through the plurality of user accounts, each member from the group of users can provide a schedule of availability, which is used to organize a number of times and dates of which a majority or all of the group of users are available to discuss travel plans. In reference to FIG. 3, each member from the group of users submits schedule data through a “schedule of times” page of the website. As such, the software program receives the schedule data from each of the plurality of user accounts and stores the schedule data in the RDB, wherein the software program generates a communal schedule of availability from the schedule data provided by each member from the group of users. The communal schedule of availability is then displayed to the group of users through the plurality of user accounts.

The communal schedule of availability visually depicts any potential scheduling conflicts between the group of users. An arbitrary user from the group of users may enter days which the arbitrary user is not available, or more specifically, the arbitrary user may provide times of each day during which the arbitrary user is unavailable. Alternatively, the arbitrary can submit the days and times of which the arbitrary user is available. Using the schedule data from each member from the group of users, the software program may graphically indicate mutually available days on the communal schedule of availability, such that the group of users can more readily organize and decide upon a day or days to plan the vacation.

A meeting center is provided on the main page of each of the plurality of user accounts and is displayed upon logging in to the user account. The meeting center is displayed initially upon logging in because as with any meeting, the opportunity must exist for all participants to be there on time. The possibility of having to go through additional pages in order to reach the meeting center can result in delays depending on server lag, errors, etc. Displaying the meeting center upon logging in ensures that each member from the group of users is more readily available. The meeting center supports voice over Internet Protocol (IP) communications and video over IP communications.

If there is a scheduled meeting, then the meeting center will automatically connect the group of users at the scheduled time. Through the meeting center, the group of users can interact with one another in order to form rules, procedures, plans, and means to carry out the goal of traveling as a group. Any information shared through the meeting center is exclusively available to the group of users, unless voted upon or otherwise specified by the group of users to be made public. The ability to make some or all information publicly available allows the group of users to gain further insight on the discussed travel plans, especially if there is disagreement among the group of users.

The group of users should first decide upon a time of travel, such that a deadline can be established up until which the group of users can join funds for the vacation. In order to fund the vacation each member from the group of users can contribute money to a communal account. In the preferred embodiment of the present invention, each member from the group of users can contribute to the communal account until approximately one to two weeks before the deadline, at which point the budget for the vacation is finalized and the final travel plans can be set.

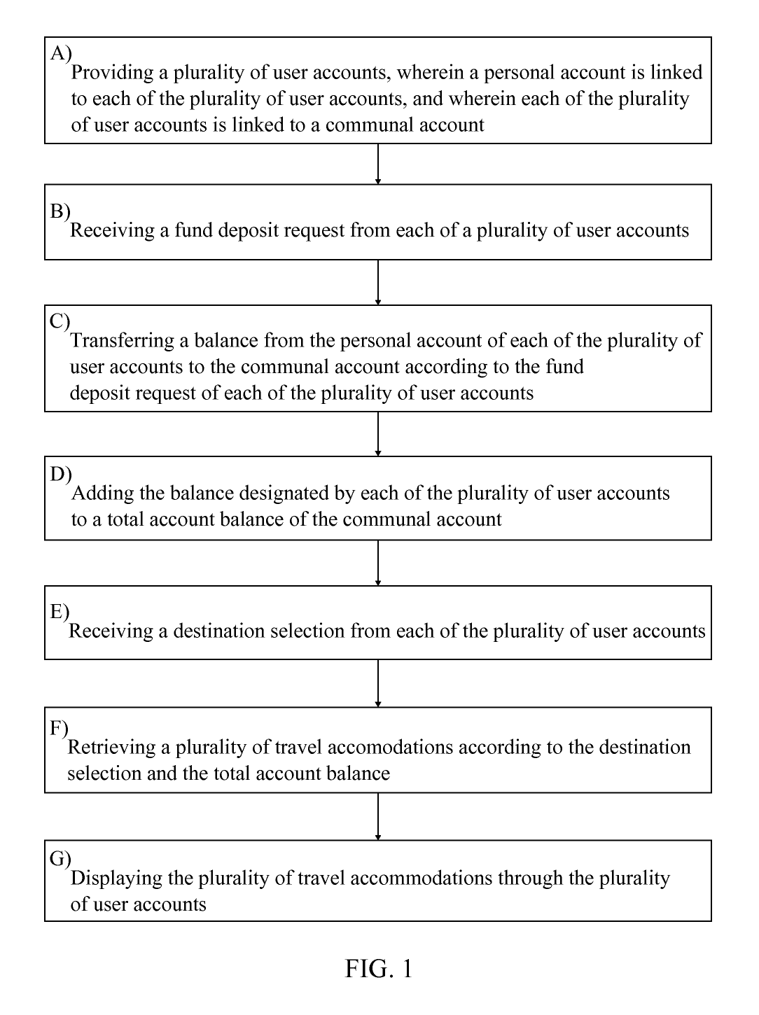

In reference to FIG. 1, a personal account is linked to each of the plurality of user accounts, wherein the personal account is used to deposit funds into the communal account. The personal account for an arbitrary user from the group of users is opened through a bank operating through the website, wherein the personal account is not associated with any other banking accounts of the arbitrary user. Money from the other banking accounts of the arbitrary user can be transferred to the personal account, wherein the funds in the personal account are used exclusively for traveling. The personal account being a standalone bank account separate from the other banking accounts of the arbitrary user, assists the arbitrary user in saving for a vacation as the arbitrary user will be less tempted to dip into the funds of the savings account unless absolutely necessary.

The group of users may decide to contribute equally to the communal account or contribute unequal amounts, depending on the rules established by the group of users. Parameters may also be utilized to anonymize the amount of money contributed by each member from the group of users if there is no limit to the contributions made to the communal account. In order to contribute to the communal account a fund deposit request must be made through the user account. The software program receives the fund deposit request from the plurality of user accounts and proceeds to transfer a balance from the personal account of each of the plurality of user accounts to the communal account according to the fund deposit request of each of the plurality of user accounts.

The frequency with which the fund deposit request can also be set within the software program. By default the fund deposit request denotes a onetime transaction between the personal account and the communal account. However, the fund deposit request can be set to reoccur over a period of time, allowing for automatic payments from the personal account to the communal account. For example, the fund deposit request could be set to be made through the user account once a month, at which point the designated amount of money is transferred from the personal account to the communal account.

The fund deposit request for each of the plurality of user accounts is made through a funding page of the website. Each member from the group of users may designate the amount of money to contribute through an input field provided on the funding page. Upon entering the fund deposit request, the software program checks the balance of the personal account in order to ensure that sufficient funds are available to make the deposit into the communal account. Once the balance from the personal account of each of the plurality of user accounts is transferred to the communal account, the balance designated by each of the plurality of user accounts is added to a total account balance of the communal account.

The total account balance is the total amount of money that the group of users has to spend on all aspects of the vacation. As such, the total account balance can be budgeted as seen fit by the group of users. For example, if the group of users prefers to spend more money on hotels than on actual travel, then the total account balance can be distributed accordingly. In this way, the amount of funding for each aspect of the vacation is transparent and agreed upon by the group of users.

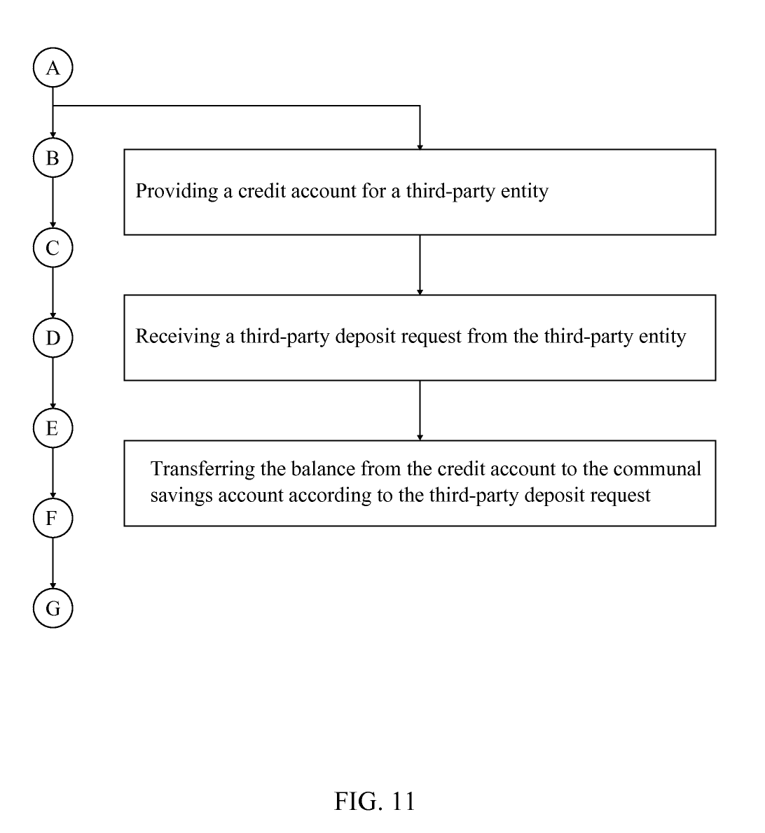

In reference to FIG. 11, if agreed upon by the group of users, a third-party entity may also be used to fund the vacation. The third-party entity can be a single person, a corporation, a group funding platform, etc. The third-party entity establishes a third-party account through the web site to allow the third-party entity contribute funds to the communal account of the group of users. A credit account is linked to the third-party account, wherein the credit account retains the funds of the third-party entity. When the third-party entity makes a deposit, the software program receives a third-party deposit request from the third party account and proceeds to transfer the balance from the credit account to the communal account according to the third-party deposit request. In another embodiment of the present invention, it is possible for the third-party entity to contribute to the communal account without establishing the third-party account through the website. The third-party entity can simply provide the required payment information, such as a bank account number, routing number, credit card number, etc. The payment information is then used to directly transfer funds to the communal account without the need of the third-party account.

In reference to FIG. 1, as the communal account continues to receive funds, the group of users can each make destination selections for locations that each member from the group of users would like to travel to. The software program receives the destination selection from each of the plurality of user accounts, wherein the group of users can then decide upon a final destination to which the group of users would like to travel. The final destination can be selected unanimously, by majority vote, randomly, or in any other manner according to the rules set forth by the group of users. Once the final destination is decided upon, the final destination is set in the software program, wherein the destination selection for the final destination is saved in the RDB.

In further reference to FIG. 1, upon saving the destination selection for the final destination in the RDB, the software program retrieves a plurality of travel accommodations according to the destination selection and the total account balance. The plurality of travel accommodations includes, but is not limited to, hotel reservations, car rentals, plane tickets, destination eateries, and local entertainment. Each of the plurality of travel accommodations is either provided by a third-party resource provider or is selected from the RDB through a search. The plurality of travel accommodations is displayed though the plurality of user accounts, such that the group of users may view, like, and share particular travel accommodations from the plurality of travel accommodations.

Using the destination selection and the total account balance, the third-party resource provider is able to construct targeted advertisements to the group of users. For example, if the total account balance is two thousand dollars and the destination selection is for Cancun, then the third-party resource provider will not show advertisements for travel packages in Cancun that exceed two thousand dollars. This is beneficial to both the group of users and the third-party resource provider, as the group of users do not receive unwanted or unnecessary advertisements and the third-party resource provider does not need to waste time and money advertising for unwanted products.

In the preferred embodiment of the present invention, the total account balance is represented as a star rating according to the destination selection. The star rating allows the third-party resource provider to readily categorize the total account balance and provide relevant advertisements for the destination selection to the group of users. For example, if the total account balance equates to three out of five stars, then the third-party resource provider can present advertisements having a three star tag. The star rating is dependent on the total account balance, the total number of travelers in the group of users, and the destination selection in order to account for the fluctuation in costs according to location.

A communications hub is provided through which the group of users can receive the plurality of travel accommodations from a third-party resource provider via internal messaging, or external messaging (e.g. email). Through the communications hub, each member of the group of users can toggle the receipt of the travel accommodations from the third-party resource provider. For example, if an arbitrary user from the group of users does not want to receive targeted advertisements from any third-party company or from a specific third-party company, then such settings can be changed through the communications hub.

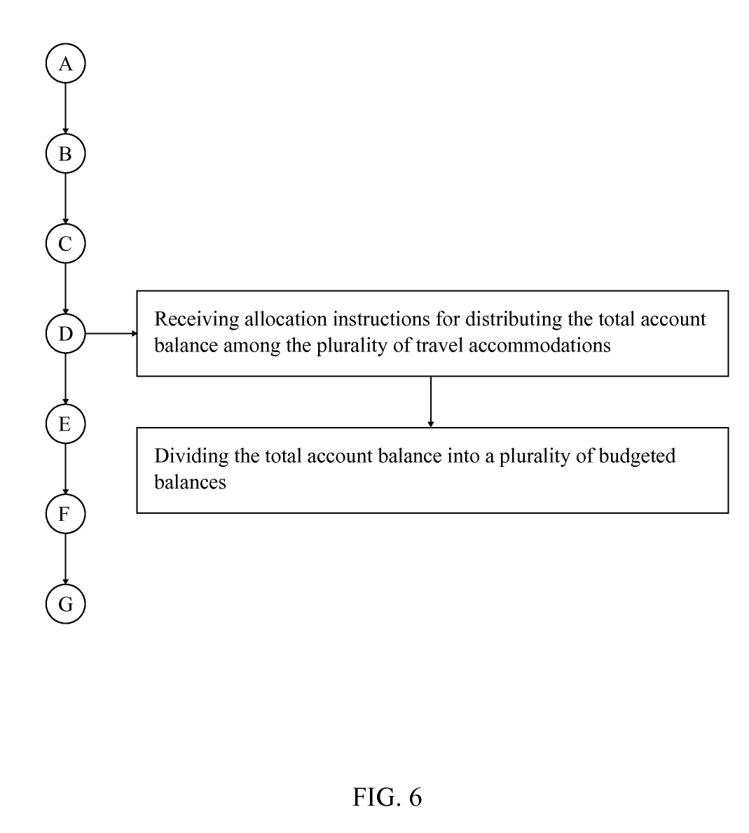

In reference to FIG. 6, if the group of users decides to budget the total account balance, then the group of users provides allocation instructions for distributing the total account balance amongst the needed travel accommodations. The software program receives the allocation instructions from distributing the total account balance among the plurality of travel accommodations and divides the total account balance into a plurality of budgeted balances. Each of the plurality of budgeted balances is associated with a type of travel accommodation, such as a hotel expense, plane ticket expense, etc. In this way, the third-party resource provider can supply even more targeted advertisements knowing the exact budget for each aspect of the vacation.

The communications hub also allows the group of users to share travel accommodations with each other. Travel accommodations can be shared with the group of users in a number of ways. One such way is via internal messaging (or external messaging, such as email), wherein the travel accommodations are selected by an arbitrary user and then directed to the rest of the group of users. Another way to share the travel accommodations with the group of users is by “liking”, or otherwise marking, the travel accommodations. Once marked, the travel accommodations are shared with the group of users automatically, either through email or by being displayed on a shared page of travel accommodations.

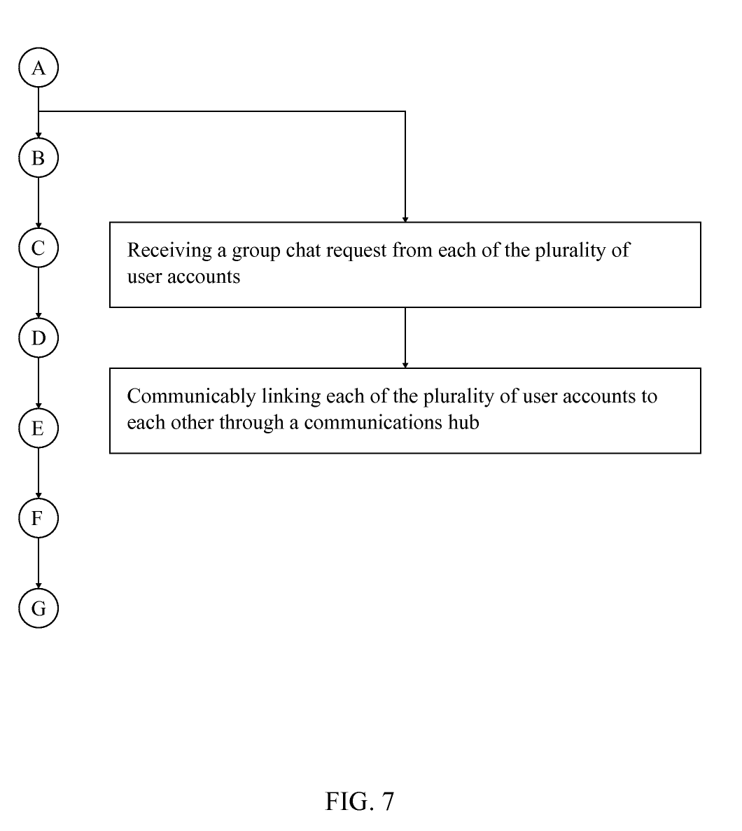

Similar to the meeting center, the communications hub allows for voice over Internet Protocol (IP) communications and video over IP communications, which can be used to establish contact with the group of users during unscheduled meeting times, a third-party resource provider, or the bank. In reference to FIG. 7, if the entire group of users wishes to group chat, then the software program receives a group chat request from each of the plurality of user accounts, wherein the software program then communicably links each of the plurality of user accounts to each other through the communications hub using voice communications and/or video communications.

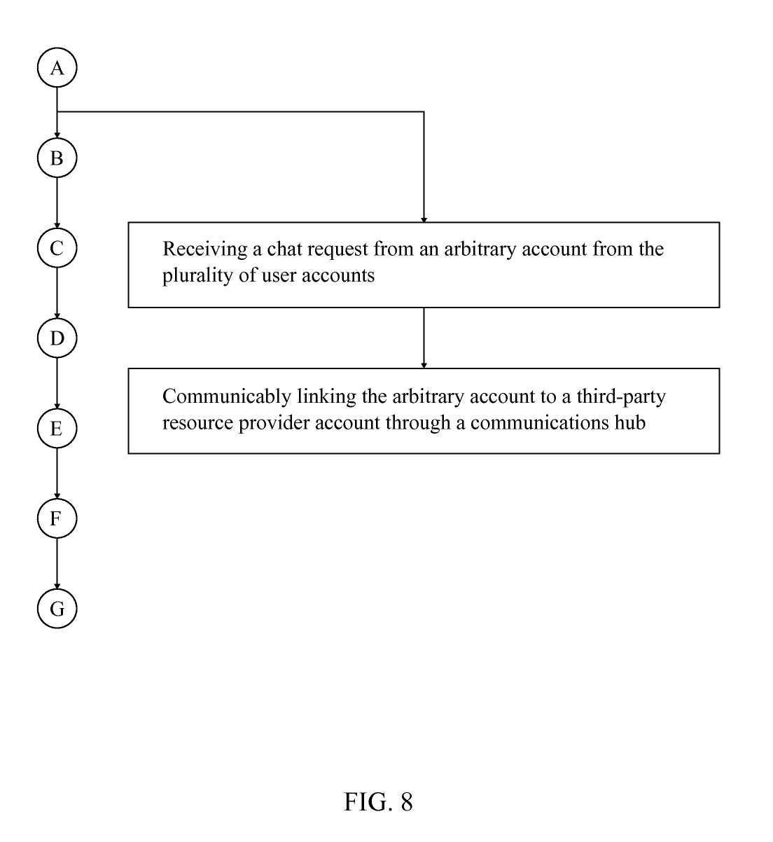

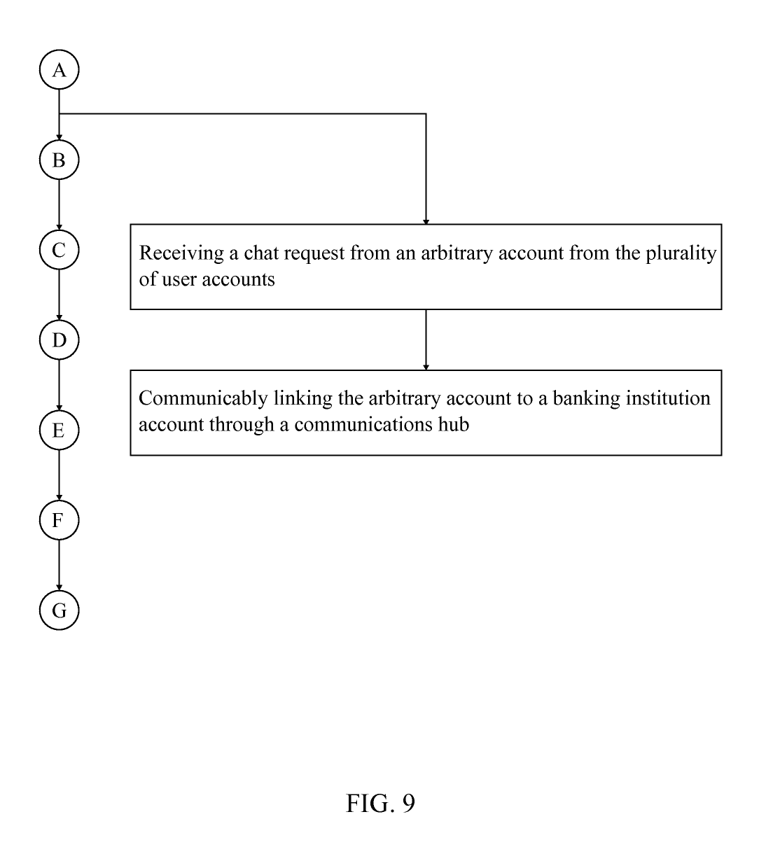

In reference to FIG. 8-9, similarly, an arbitrary user from the group of users can establish communications with the third-party resource provider or the bank via the communications hub through an arbitrary account from the plurality of user accounts. The software program receives a chat request from the arbitrary account, when the chat request is made by the arbitrary user. Upon receiving the chat request, the software program communicably links the arbitrary account to either a third-party resource provider account associated with the third-party resource provider, or to a banking institution account associated with the bank. The third-party resource provider account and the banking institution account allow the third-party resource provider and the bank, respectively, to interact with the software program.

The communications hub can also be used to directly communicate travel information from third-party resource providers to the group of users once a trip has been booked. For example, if the group of users purchases airline tickets, then boarding passes can be provided from the airline to the group of users through the communications hub, wherein the group of users can then readily utilize the boarding passes. Travel information can be displayed to the group of users on the day the travel information is to be used, such as for boarding passes, or may be available a few days in advance depending on preferences of the third-party resource provider. Alternatively, the travel information may be displayed to the group of users automatically upon signing in to the plurality of user accounts. In this way, the group of users can readily check plans or necessary information each day of the trip.

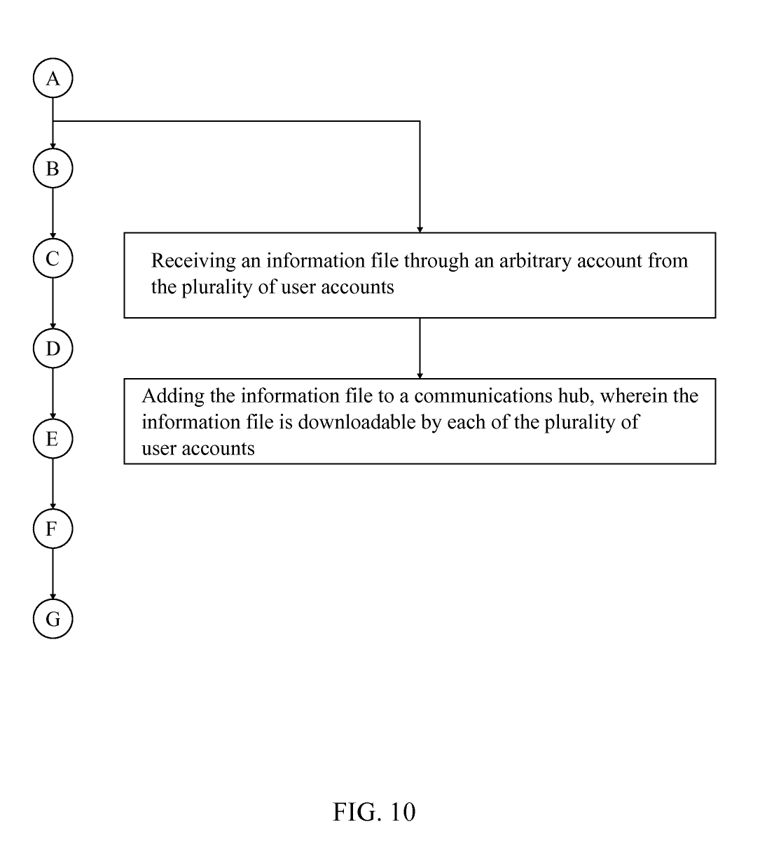

The website also provides the group of users with resources for finding and determining the travel accommodations. The website provides pages for accessing libraries, online journals, news, vendors/resource providers, travel information, self-help travel tips, etc. Once accessed, such information can be tagged and shared with the group of users through the communications hub. Additionally and in reference to FIG. 10, the group of users can upload information to share through the communications hub. For the arbitrary user from the group of users, an information file can be uploaded through the arbitrary account of the arbitrary user. Upon receiving the information file from the arbitrary account, the software program adds the information file to the communications hub, wherein the information file is downloadable through each of the plurality of user accounts. The information file can be any format of information, such as a text file, image file, spreadsheet file, etc.

In addition to researching and planning travel accommodations, the present invention also provides a means for sharing past vacations with other users. Once a vacation has occurred, each member from the group of users can upload photos and written reviews of the vacation. Photos and written reviews can be shared with friends only, or the entire public depending on the preference of the user. Not only do the photos and written reviews allow a user to share his or her experience with other users, but the written reviews also can provide insight for other users looking to vacation in the same location. In this way, the written reviews serve as further research material that can be utilized by other users to plan and book a vacation.

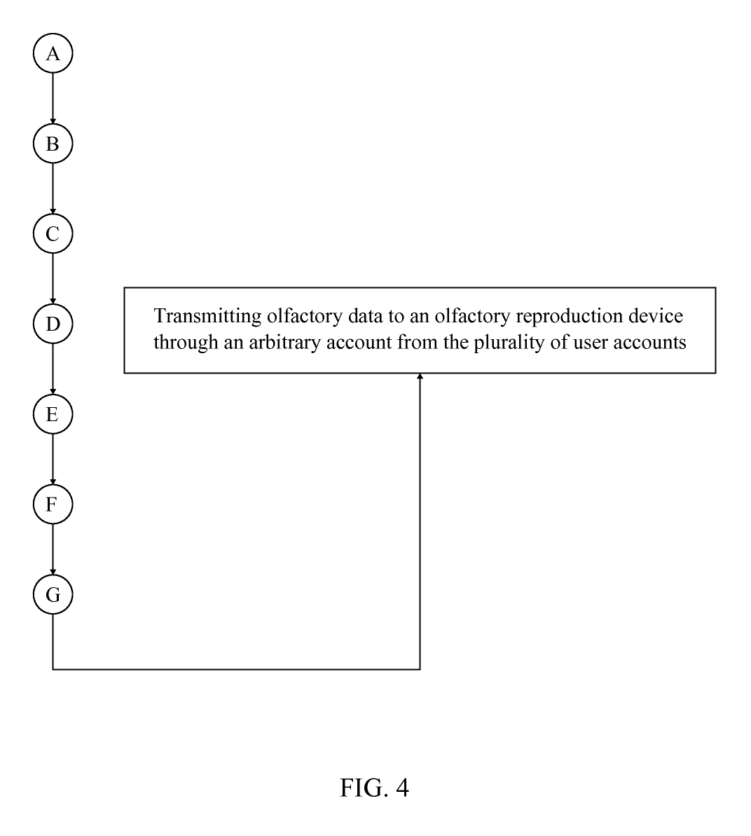

In reference to FIG. 4, depending on current technologies, it may also be possible to share information relating to senses such as smell and taste. Provided an olfactory reproduction device that is linked to an arbitrary account from the plurality of user accounts, it is possible to reproduce and share smells among users. The software program receives olfactory data for the desired sent to be transmitted either from a third-party resource provider or from another user account. The software program then transmits the olfactory data to the olfactory reproduction device through the arbitrary account, wherein the olfactory reproduction device reproduces the desired scent for the arbitrary user. Such technology is more beneficial for the third-party resource provider as it allows the third-party resource provider to send a more enhanced representation of services or location.

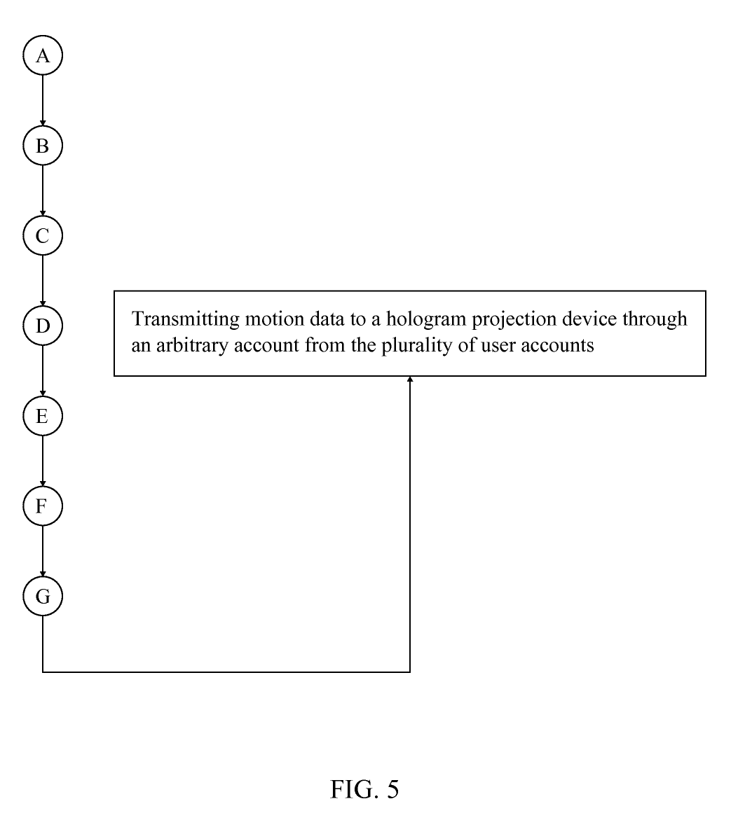

In reference to FIG. 5, again, depending on current technologies, it may be possible to provide visual representations of locations and/or people using holograms. Provided a hologram projection device that is linked to an arbitrary account from the plurality of user accounts, it is possible to reproduce people and landscapes. The software program receives motion data, or visual data, for an individual or a landscape, and then transmits the motion data, or visual data, to the hologram projection device through the arbitrary account. This provides more immersion for the group of users, allowing each member of the group of users to feel as if they are the specific location or in the same room as an individual.

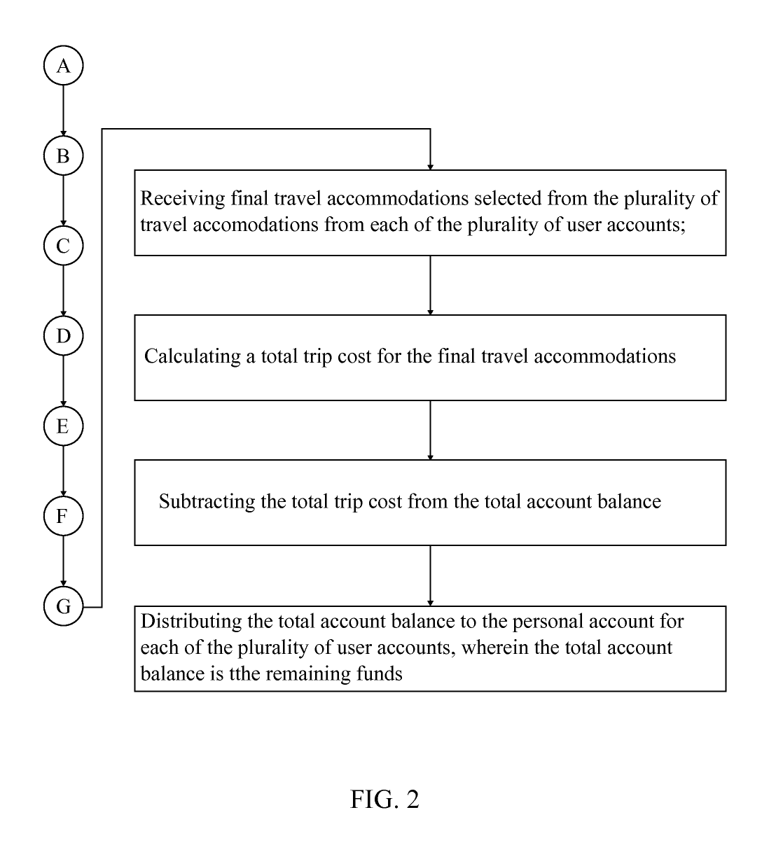

In reference to FIG. 2, once the group of users has gathered sufficient information on the final destination, the group of users must agree upon final travel accommodations selected from the plurality of travel accommodations gathered. Once the group of users agrees upon the final travel accommodations, the software program stores the final travel accommodations and calculates a total trip cost for the final travel accommodations. For example, the total trip cost would include planned hotel rentals, car rentals, plane tickets, etc. The total trip cost is then subtracted from the total account balance, leaving a remaining balance for the communal account. The software program may provide means for distributing and making payments directly to resource providers using the communal account once the final travel accommodations have been decided.

If there is the remaining balance once the total trip cost has been subtracted from the total account balance, then the remaining balance becomes the total account balance. The total account balance can then either be distributed amongst the group of users or applied to additional travel plans. If the former is chosen, then the software program distributes the total account balance to the personal account for each of the plurality of user accounts. Each member of the group of users can then either withdraw the additional funds from the personal account or use the additional funds later for a subsequent vacation.

In another modality of the present invention, the software program can be utilized by single individuals trying to organize travel plans alone. For example, the head of a family acting as a sole participant of the website, can use the website as a means to coordinate and apply resources for the family to travel.

Although the software program is designed to facilitate travel planning by providing filtered search results that are determined by the total account balance, the total number of travelers in the group of users, and the destination selection, the group of users is not limited to only the filtered results. As another function of the present invention, the filtered search results for the travel accommodations are displayed on one page, wherein the option of viewing search results for the travel accommodations greater exceeding the total account balance is provided. By viewing a second page, each member from the group of users can view the travel accommodations outside of the budget, wherein a remaining cost is displayed being the difference between the total account balance and the cost of the travel accommodations. Funds for the remaining cost can then be added to the total account balance in order to book the travel accommodations. For example, if the total account balance for a group is five thousand dollars, but the cost of the travel accommodations is six thousand dollars, then the remaining cost displayed would be one thousand dollars.

Although the invention has been explained in relation to its preferred embodiment, it is to be understood that many other possible modifications and variations can be made without departing from the spirit and scope of the invention as hereinafter claimed.

What is claimed is:

1. A method for facilitating travel plans and managing a communal budget by executing computer-executable instructions stored on a non-transitory computer-readable medium, the method comprises the steps of:
providing a plurality of user accounts, wherein a personal account is linked to each of the plurality of user accounts, and wherein each of the plurality of user accounts can be linked to a communal account;
receiving a fund deposit request from each of the plurality of user accounts;
transferring a balance from the personal account of each of the plurality of user accounts to the communal account according to the fund deposit request of each of the plurality of user accounts;
adding the balance designated by each of the plurality of user accounts to a total account balance of the communal account;
receiving a destination selection from each of the plurality of user accounts;
retrieving a plurality of travel accommodations according to the destination selection and the total account balance; and
displaying the plurality of travel accommodations through the plurality of user accounts.

2. The method for facilitating travel plans and managing a communal budget by executing computer-executable instructions stored on a non-transitory computer-readable medium, the method as claimed in claim 1, wherein each of the plurality of travel accommodations is provided by a third-party resource provider.

3. The method for facilitating travel plans and managing a communal budget by executing computer-executable instructions stored on a non-transitory computer-readable medium, the method as claimed in claim 1, wherein each of the plurality of travel accommodations is selected from a relational database.

4. The method for facilitating travel plans and managing a communal budget by executing computer-executable instructions stored on a non-transitory computer-readable medium, the method as claimed in claim 1 further comprises the steps of:
receiving final travel accommodations selected from the plurality of travel accommodations from each of the plurality of user accounts;
calculating a total trip cost for the final travel accommodations; and
subtracting the total trip cost from the total account balance.

5. The method for facilitating travel plans and managing a communal budget by executing computer-executable instructions stored on a non-transitory computer-readable medium, the method as claimed in claim 4 further comprises the steps of:
distributing the total account balance to the personal account for each of the plurality of user accounts, wherein the total account balance represents a remaining balance.

6. The method for facilitating travel plans and managing a communal budget by executing computer-executable instructions stored on a non-transitory computer-readable medium, the method as claimed in claim 4, wherein the final travel accommodations is unanimously decided upon.

7. The method for facilitating travel plans and managing a communal budget by executing computer-executable instructions stored on a non-transitory computer-readable medium, the method as claimed in claim 4, wherein the final travel accommodations is decided by majority vote.

8. The method for facilitating travel plans and managing a communal budget by executing computer-executable instructions stored on a non-transitory computer-readable medium, the method as claimed in claim 1 further comprises the steps of:
receiving schedule data from each of the plurality of user accounts;
generating a communal schedule of availability from the schedule data; and
displaying the communal schedule of availability through each of the plurality of user accounts.

9. The method for facilitating travel plans and managing a communal budget by executing computer-executable instructions stored on a non-transitory computer-readable medium, the method as claimed in claim 8 further comprises the steps of:
graphically indicating mutually available days on the communal schedule of availability.

10. The method for facilitating travel plans and managing a communal budget by executing computer-executable instructions stored on a non-transitory computer-readable medium, the method as claimed in claim 1, wherein voice over internet protocol capability is provided for communication amongst each of the plurality of user accounts through a communications hub.

11. The method for facilitating travel plans and managing a communal budget by executing computer-executable instructions stored on a non-transitory computer-readable medium, the method as claimed in claim 1, wherein video over internet protocol capability is provided for communication amongst each of the plurality of user accounts through a communications hub.

12. The method for facilitating travel plans and managing a communal budget by executing computer-executable instructions stored on a non-transitory computer-readable medium, the method as claimed in claim 1 further comprises the steps of:
transmitting olfactory data to an olfactory reproduction device through an arbitrary account from the plurality of user accounts.

13. The method for facilitating travel plans and managing a communal budget by executing computer-executable instructions stored on a non-transitory computer-readable medium, the method as claimed in claim 1 further comprises the steps of:
transmitting motion data to a hologram projection device through an arbitrary account from the plurality of user accounts.

14. The method for facilitating travel plans and managing a communal budget by executing computer-executable instructions stored on a non-transitory computer-readable medium, the method as claimed in claim 1 further comprises the steps of:
receiving allocation instructions for distributing the total account balance among the plurality of travel accommodations; and
dividing the total account balance into a plurality of budgeted balances.

15. The method for facilitating travel plans and managing a communal budget by executing computer-executable instructions stored on a non-transitory computer-readable medium, the method as claimed in claim 1, wherein the total account balance is represented as a star rating according to the destination selection.

16. The method for facilitating travel plans and managing a communal budget by executing computer-executable instructions stored on a non-transitory computer-readable medium, the method as claimed in claim 1 further comprises the steps of:
receiving a group chat request from each of the plurality of user accounts; and
communicably linking each of the plurality of users accounts to each other through a communications hub.

17. The method for facilitating travel plans and managing a communal budget by executing computer-executable instructions stored on a non-transitory computer-readable medium, the method as claimed in claim 1 further comprises the steps of:
receiving a chat request from an arbitrary account from the plurality of user accounts; and
communicably linking the arbitrary account to a banking institution account through a communications hub.

18. The method for facilitating travel plans and managing a communal budget by executing computer-executable instructions stored on a non-transitory computer-readable medium, the method as claimed in claim 1 further comprises the steps of:
receiving a chat request from an arbitrary account from the plurality of user accounts; and
communicably linking the arbitrary account to a third-party resource provider account through a communications hub.

19. The method for facilitating travel plans and managing a communal budget by executing computer-executable instructions stored on a non-transitory computer-readable medium, the method as claimed in claim 1 further comprises the steps of:
receiving an information file through an arbitrary account from the plurality of user accounts; and
adding the information file to a communications hub, wherein the information file is downloadable through each of the plurality of user accounts.

20. The method for facilitating travel plans and managing a communal budget by executing computer-executable instructions stored on a non-transitory computer-readable medium, the method as claimed in claim 1 further comprises the steps of:
providing a credit account for a third-party entity;
receiving a third-party deposit request from the third-party entity; and
transferring the balance from the credit account to the communal account according to the third-party deposit request.
